(19) United States
(12) Patent Application Publication
(10) Pub. No.: US 2008/0015911 A1
(43) Pub. Date: Jan. 17, 2008

(54) Methods and apparatuses for developing business solutions

(75) Inventors: Binfeng Wang, Shanghai (CN); Song Chi, Shanghai (CN)

Correspondence Address: SAP/BLAKELY, 1279 OAKMEAD PARKWAY, SUNNYVALE, CA, 94085-4040, US

(73) Assignee: SAP AG

(21) Appl. No.: 11/486,879

(22) Filed: Jul. 14, 2006

(51) Int. Cl. G06F 9/44; G06F 3/00

(52) U.S. Cl. 705/7; 715/700

(57) ABSTRACT

Integrated development environment (IDE) for developing and deploying business solutions is described herein. In one embodiment, a process for deploying an enterprise application includes, but is not limited to, presenting via a first page of a graphical user interface (GUI) data of an organization structure representing a structure of an enterprise entity associated with the enterprise application, the organization structure having one or more attributes that are editable via the first page of the GUI, and in response to a request to change at least one attribute of the organization structure via the first page of the GUI, propagating the change in one or more components of the enterprise application that reference to the at least one changed attribute. Other methods and apparatuses are also described.

### COPYRIGHT NOTICES

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to enterprise computing. More particularly, this invention relates to developing business solutions.

### BACKGROUND

As enterprise computing solutions are getting more popular, tools for developing or deploying business solutions have been provided to help IT (information technology) and functional project team members to deploy business solutions. Some of toolsets may include a mix of step-by-step instructions, preconfiguration, sample master data, code samples (where applicable), and end-user training, which are organized by technical or business scenarios that may fit a particular enterprise.

A business solution may include multiple components, also referred to as building blocks (BBs) which may further include multiple data sets, also referred to as BC-sets (business configuration sets) or eCATTs (extended computer aided test tool).

However, conventional development toolsets lack user-friendly user interfaces to allow a developer or an administrator to easily develop or deploy a business solution. For example, if a parameter that is used in multiple components (e.g., BBs, BC-sets, eCATTs) is changed, a user has to manually change the parameter in some or all of the affected components. Conventional toolsets also lack a central user interface to edit such parameters and propagate such edited parameters into proper components automatically.

In addition, a business solution for an enterprise is structured by an organization structure associated with the enterprise. Conventional toolsets typically implement a fixed organization identity and a user cannot use its own organization codes. Further, there has been a lack of linking mechanisms to link components of a business solution with external components, particularly, when a business solution is being deployed. As a result, conventional toolsets tend to be more expensive and less user friendly.

### SUMMARY OF THE DESCRIPTION

Integrated development environment (IDE) for developing and deploying business solutions is described herein. In one embodiment, a process for deploying an enterprise application includes, but is not limited to, presenting via a first page of a graphical user interface (GUI) data of an organization structure representing a structure of an enterprise entity associated with the enterprise application, the organization structure having one or more attributes that are editable via the first page of the GUI, and in response to a request to change at least one attribute of the organization structure via the first page of the GUI, propagating the change in one or more components of the enterprise application that reference to the at least one changed attribute.

Other features of the present invention will be apparent from the accompanying drawings and from the detailed description which follows.

### BRIEF DESCRIPTION OF THE DRAWINGS

The present invention is illustrated by way of example and not limitation in the figures of the accompanying drawings in which like references indicate similar elements.

FIG. 1 is a block diagram illustrating a system for developing a business solution according to one embodiment of the invention.

FIGS. 2A and 2B are flow diagrams illustrating certain processes for developing and deploying a business solution according to certain embodiments of the invention.

FIG. 3 is a diagram illustrating a GUI of an IDE for developing and/or deploying a business solution according to one embodiment of the invention.

FIGS. 4A-4F are diagrams illustrating GUIs of an IDE for developing and/or deploying a business solution according to one embodiment of the invention.

FIG. 5 is a diagram illustrating a GUI of an IDE for developing and/or deploying a business solution according to one embodiment of the invention.

FIGS. 6A and 6B are diagrams illustrating GUIs for creating a building block according to one embodiment of the invention.

FIGS. 7A and 7B are diagrams illustrating GUIs for manipulating a task of a building block, according to one embodiment of the invention.

FIG. 8 is a flow diagram illustrating a process for building and/or modifying a building block according to one embodiment of the invention.

FIGS. 9A and 9B are diagrams illustrating a process for activating a building block using user defined organization type, according to one embodiment of the invention.

FIG. 10 is a block diagram illustrating a process to activate parameters of a building block having language dependent organization types, according to one embodiment of the invention.

FIGS. 11A and 11B are block diagrams illustrating a process to activate parameters of a building block having storage location dependent organization types, according to one embodiment of the invention.

FIG. 12 is a flow diagram illustrating a process of activating a parameter having dependent values as described above according to one embodiment of the invention.

FIG. 13 is a diagram illustrating a GUI of a solution implementation according to one embodiment of the invention.

FIGS. 14A and 14B are diagrams illustrating GUIs of modifying or editing a solution according to one embodiment of the invention.

FIG. 15 is a diagram illustrating a GUI for activating a solution according to one embodiment of the invention.

FIG. 16 is a diagram illustrating a GUI of a scenario composer according to one embodiment of the invention.

FIG. 17 is a flow diagram illustrating a process for activating a solution according to one embodiment of the invention.

### DETAILED DESCRIPTION

Integrated development environment (IDE) for developing and deploying business solutions is described herein. In the following description, numerous details are set forth to provide a more thorough explanation of embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment.

In one embodiment, an IDE for developing a business solution provides visible organization structure in the system; provides variable organization unit codes; provide an automated solution implementation method to activate individualized organization units code in the system; fully reuse sub-component functionality by providing external activation variant files. As a result, such an IDE can avoid significant troubleshooting effort and inconvenient changeability, which leads to fast go-to-market and solution development time and lower the cost throughout solution lifecycles.

For example, such an IDE may be utilized by some enterprise solution development tools, such as, for example, SAP Best Practices™ that helps IT and functional project team members to quickly deploy SAP solutions, for example, from SAP NetWeaver™ available from SAP AG. Note that throughout this application, for the illustration purposes, an SAP solution development system is used as an example to illustrate techniques of embodiments of the invention. However, it is not so limited. It will be appreciated that other enterprise development environments or toolsets may also be applied.

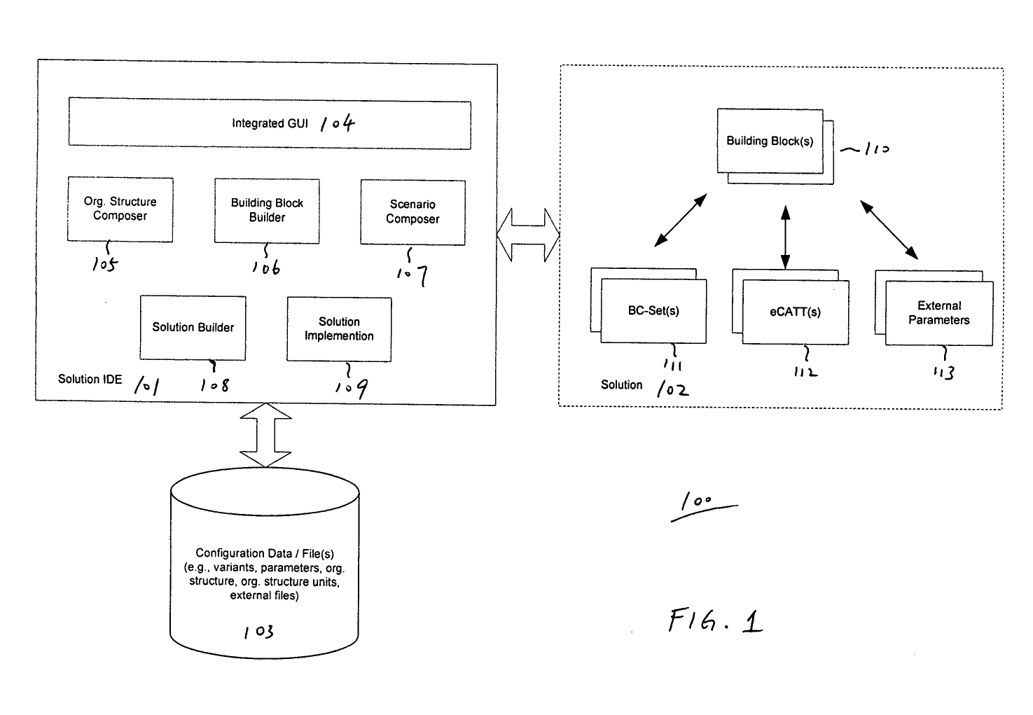

FIG. 1 is a block diagram illustrating a system for developing a business solution according to one embodiment of the invention. Referring to FIG. 1, system 100 includes a business solution IDE 101 to enable a developer or administrator to develop or deploy (e.g., activate) a business solution 102 using one or more configuration data sets 103. For example, IDE 101 may be implemented as part of SAP Best Practices™ development solutions, for example, from SAP NetWeaver™ available from SAP AG.

Referring to FIG. 1, in one embodiment, IDE 101 includes, but is not limited to, an organization structure composer 105 to manipulate an organization structure, a building block (BB) builder 106 to build one or more building blocks, a scenario composer 107 to create a business scenario, a solution builder 108 to create a business solution, and a solution implementation unit 109 to activate or deploy a business solution.

Note that these components may be implemented as software, hardware, or a combination of both. These components may be implemented in separate functional units coupled to one another, for example, via inter-process communications. Alternatively, these components may be integrated as a single unit having different functionalities, routines, or libraries. Further, some or all of these components may be implemented using object-oriented techniques, such as, for example, Java available from Sun Microsystems or .NET framework available from Microsoft.

Referring to FIG. 1, IDE 101 further includes a graphical user interface (GUI) 104 which may be utilized to present some or all of the configuration data sets 103 and allow a developer or administrator to manipulate the data sets, such as an organization structure or certain variants, in order to develop or deploy solution 102.

In one embodiment, configuration data 103 may include one or more data structures or tables for storing most necessary data used to develop or deploy solution 102. These data sets may be implemented via one or more databases, locally or remotely. Solution 102 may be developed or deployed using IDE 101, where solution 102 may be constructed by one or more building blocks 110. Each building block may be constructed or linked with one or more BC-sets 111, eCATTs 112, and/or one or more external parameters 113. Again, these components are shown for illustration purposes only and other configurations may exist.

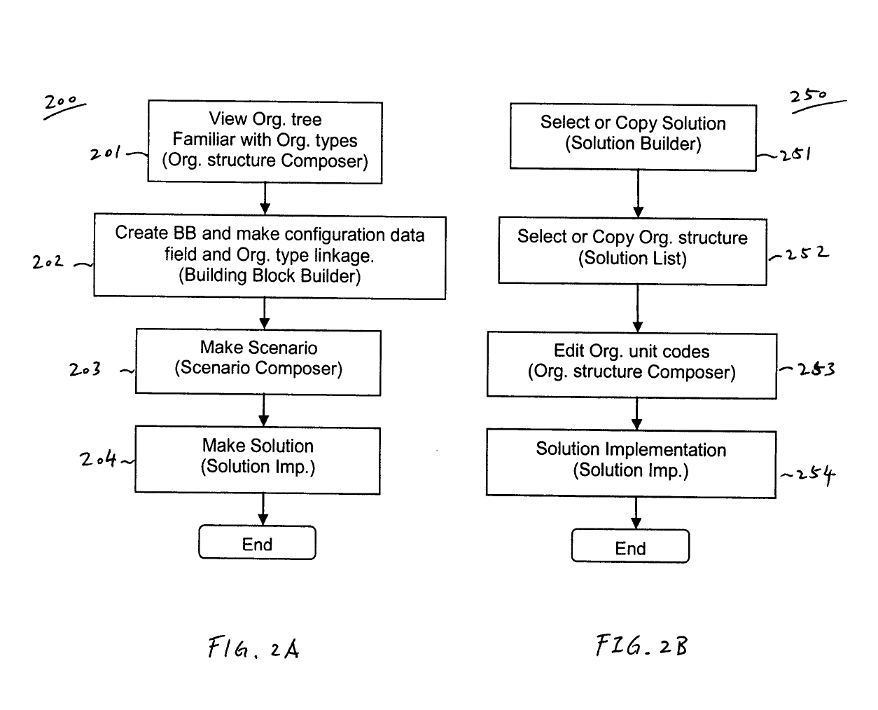

According to certain embodiments of the invention, IDE 101 may be used to both develop a business solution and activate or deploy a business solution. FIGS. 2A and 2B are flow diagrams illustrating certain processes for developing and deploying a business solution according to certain embodiments of the invention. Note that any part of the processes as shown may be performed by processing logic that may include software, hardware, or a combination of both. For example, process 200 of FIG. 2A and/or process 250 of FIG. 2B may be performed by IDE 101 of FIG. 1.

Referring to FIG. 2A, at block 201, an organization structure may be presented or edited by a user, for example, using organization structure composer 105 of FIG. 1. In one embodiment, the organization structure composer 105 may be used to present a hierarchical structure, hereinafter referred to as an organization structure, representing an organization of an enterprise associated with the solution being developed. In addition, the organization structure composer 105 further allows a user to edit one or more fields, attributes, and/or parameters of an organization structure.

At block 202, one or more BBs (e.g., BBs 110 of FIG. 1) may be created or configured (e.g., configuration of data sets and organization type linkages), for example, using BB builder 106 of FIG. 1. At block 203, a business scenario associated with the business solution may be created, for example, using scenario composer 107 of FIG. 1. After all necessary components have been created or configured, at block 204, a business solution may be created, for example, using solution builder 108 of FIG. 1. Additional operations may also be performed.

In addition to developing a solution, the IDE may also be used to activate or deploy a solution. Referring to FIG. 2B, at block 251, an existing solution (e.g., created via process 200 of FIG. 2A) may be selected or copied, for example, using solution builder 108 of FIG. 1. In addition, at block 252, an organization structure associated with the selected solution may be assigned or reassigned, for example, using solution builder 108 of FIG. 1. At block 253, certain attributes or parameters of the organization structure, such as organization unit codes may be edited, for example, using organization composer 105 of FIG. 1. Once the selected solution has been configured completely, at block 254, the configured solution may be activated or deployed, for example, using solution implementation unit 109 of FIG. 1. Additional operations may also be performed.

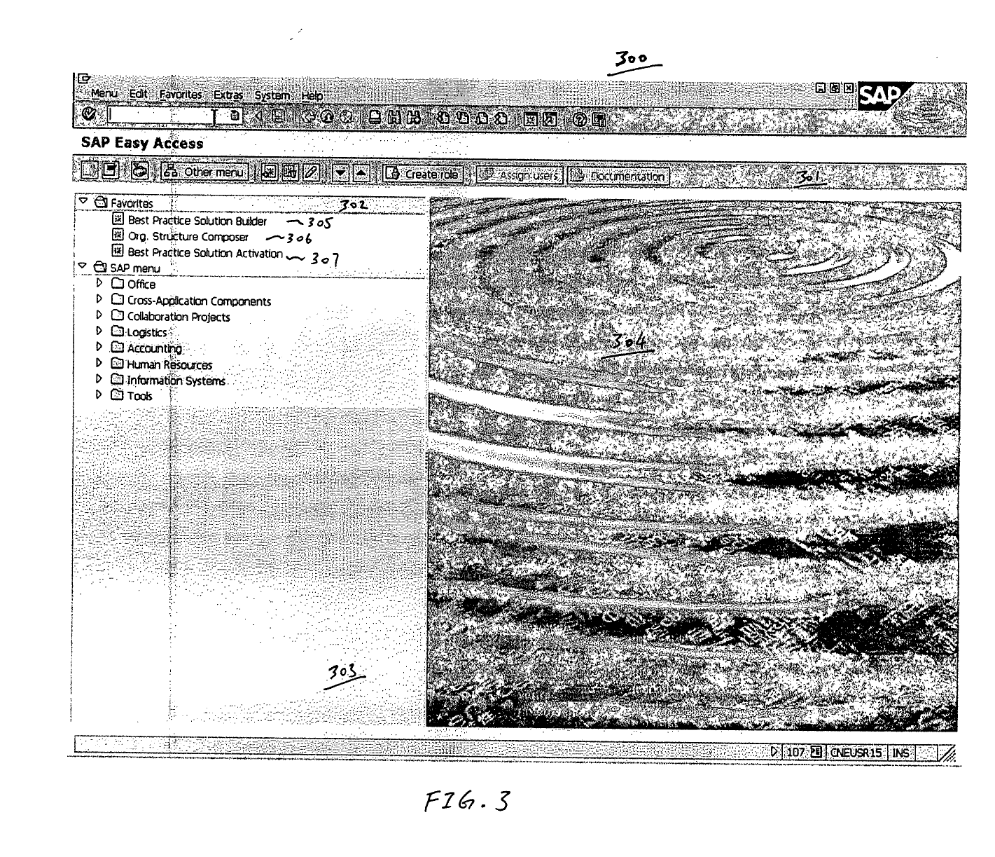

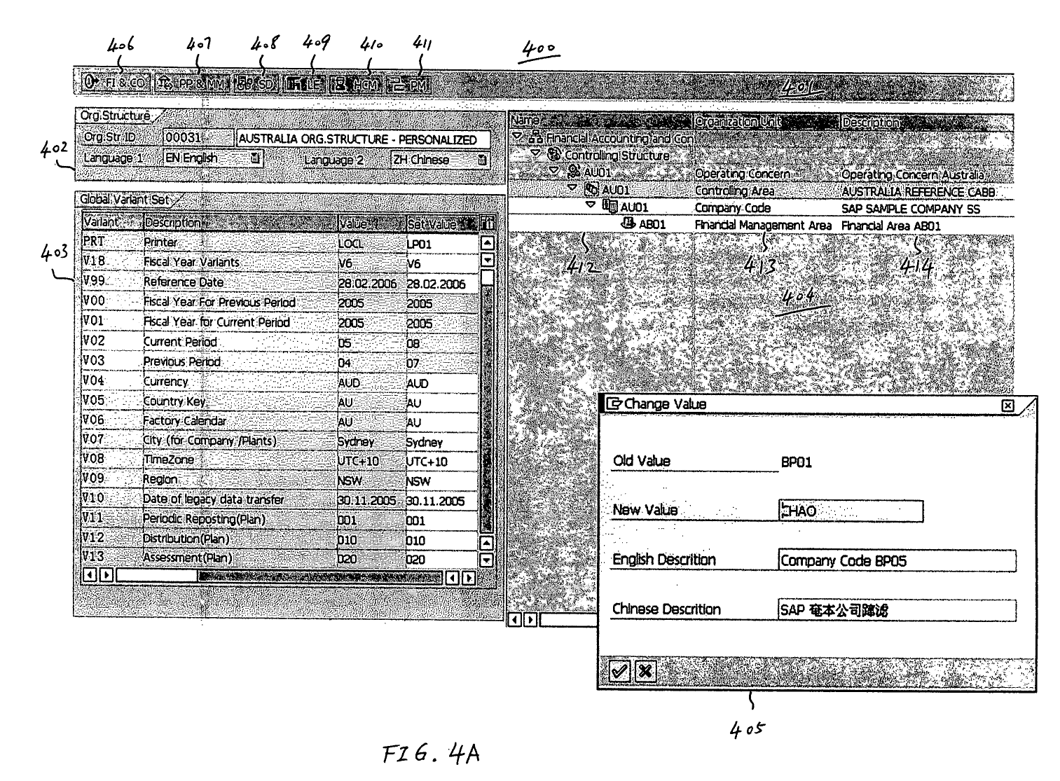

FIG. 3 is a diagram illustrating a GUI of an IDE for developing and/or deploying a business solution according to one embodiment of the invention. For example, GUI 300 may be part of GUI 104 of FIG. 1. GUI 300 may be implemented as part of enterprise business solution development toolsets, such as, for example, SAP Best Practices™ development solutions, for example, from SAP NetWeaver™ developer studio available from SAP AG. GUI 300 may be implemented by using object-oriented techniques, such as, for example, Java available from Sun Microsystems or .NET framework available from Microsoft.

Referring to FIG. 3, GUI 300 includes, but is not limited to, tool bar 301 having one or more buttons or controls, which when activated, cause an application or a process to perform certain operations. In one embodiment, GUI 300 further includes a favorite menu area 302 which may be selected from a general menu area 303 or vice versa. Each of the items in menu areas 302 and 303 may be selected or activated to display further detailed information of the selected item. The detailed information a selected item may also be displayed in window 304. Note that some or all of the items displayed in areas 302-303 may also be configured as a button in the tool bar 301 or alternatively, in one of the pull-down menus.

In this example, area 302 has been configured to include three menu items: solution builder 305, organization structure composer 306, and solution builder 307. However, other menu items may also be included. Solution builder 305, when activated, may represent certain features or functionalities of solution builder 108 of FIG. 1. Similarly, organization structure composer 306 and solution activation 307, when activated, may represent some or all of the functionalities of organization structure composer 105 and solution implementation 109 of FIG. 1 respectively.

Note that GUI 300, as well as other GUIs throughout this application, is shown and described for illustration purposes only. The functionality and the layout of the GUI may vary. For example, the toolbar 301 may be implemented at different locations of the GUI, such as, for example, at the bottom of the GUI near the status bar. The number of the buttons or controls associated with the toolbar 301 may vary. The buttons, the fields, and/or other controls may be activated through various methods. For example, those buttons, icons, and controls, etc., may be activated through one or more keys from a keyboard and/or a pointing device (e.g., a mouse). It will be appreciated that they can also be activated via other methods apparent to those with ordinary skill in the art, such as, for example, a voice interactive command, a stylus, or a command or instruction received over a network, etc. It will be appreciated that some well-known user interfaces are not shown in order not to obscure embodiments of the invention in unnecessary detail.

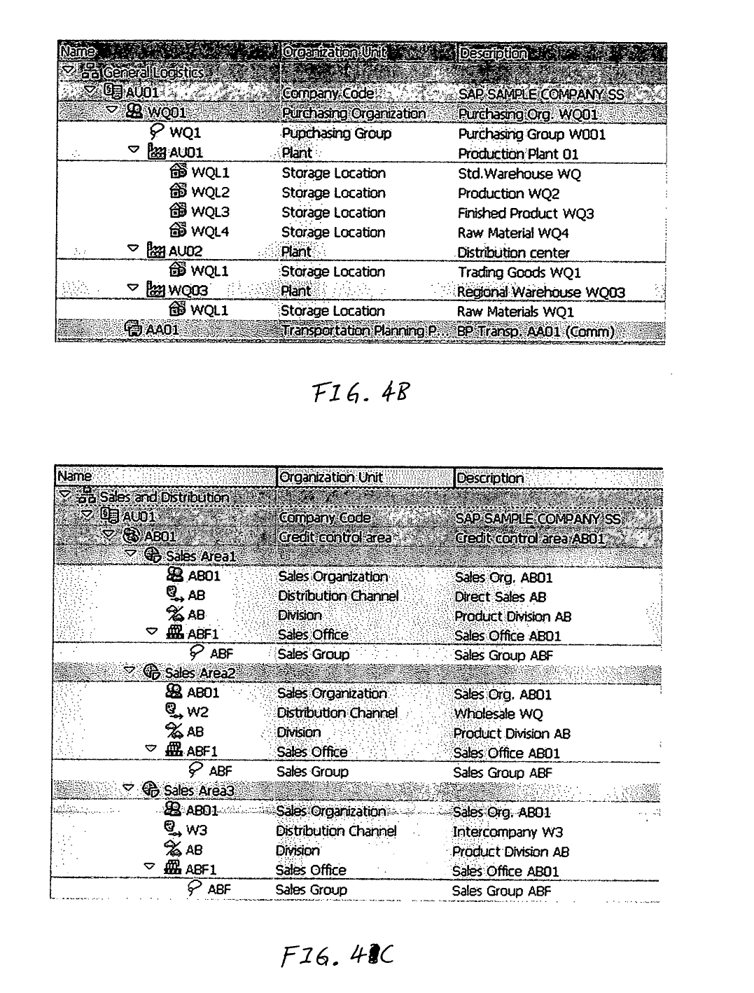

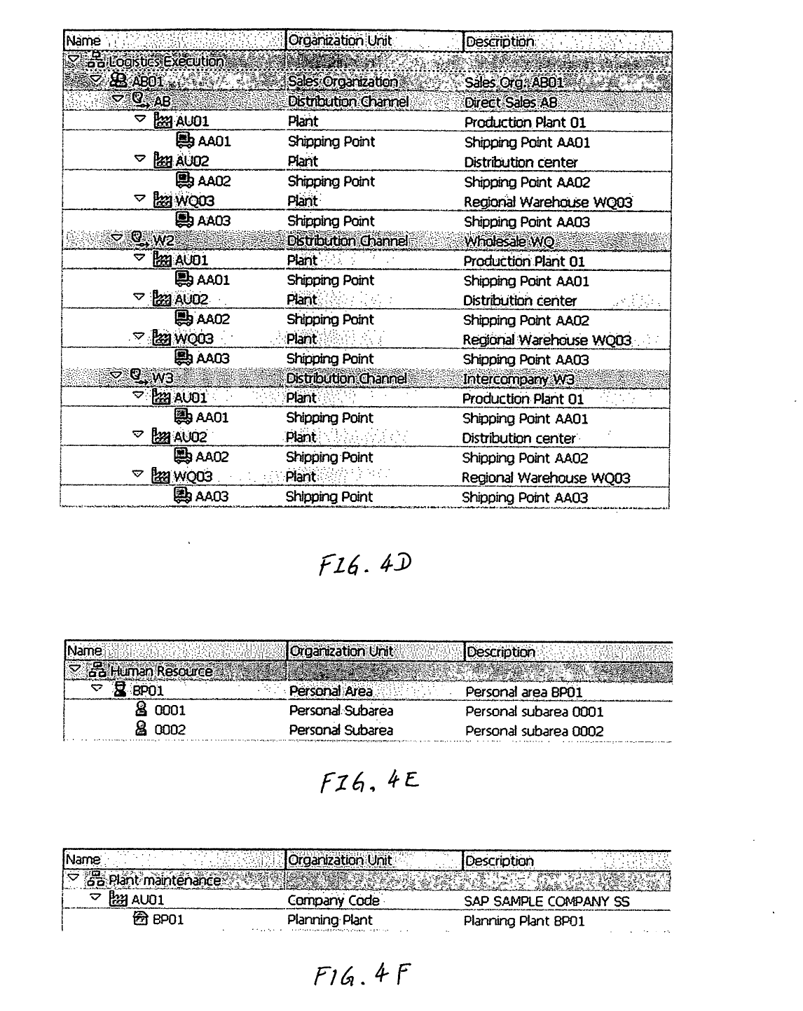

FIGS. 4A-4F are diagrams illustrating GUIs of an IDE for developing and/or deploying a business solution according to one embodiment of the invention. For example, GUI 400 may be part of a GUI for organization composer 105 of FIG. 1. In one embodiment, GUI 400 may be displayed via an activation of menu item 306 of FIG. 3. Similar to GUI 300 of FIG. 3, GUI 400 may be implemented as part of enterprise business solution development toolsets, such as, for example, SAP Best Practices™ development solutions, for example, from SAP NetWeaver™ developer studio available from SAP AG. GUI 400 may be implemented using object-oriented techniques, such as, for example, Java available from Sun Microsystems or .NET framework available from Microsoft.

Referring to FIG. 4A, in one embodiment, GUI 400 includes a toolbar 401 having one or more buttons or controls, organization structure area 402 for displaying information of the associated organization structure, a global variant area 403 for displaying information of global variants used by a solution, and a window 404 to display detailed information of organization units under the organization structure displayed in area 402. Toolbar 401 includes one or more buttons, which when activated, to display further detailed information of the corresponding buttons, which represent different departments or subsidiaries of the corresponding organization.

In this example, toolbar 401 includes buttons 406-411 which present six different sub-organizations, units, or entities of the organization displayed in area 402. When any one of the buttons 406-411 is activated, further detailed information regarding the sub-organization associated with the activated button may be displayed in area 404. For example, as shown in FIG. 4A, detailed information associated with button 406 is displayed in area 404, assuming button 406 has been activated. Similarly, FIGS. 4B-4F are diagrams illustrating certain detailed information of buttons 407-411 respectively when the corresponding buttons are activated. The information as shown in FIGS. 4B-4F may also be displayed within area 404 of FIG. 4A when the corresponding buttons 407-411 are respectively activated. Note that the number of buttons and the description of toolbar 401 are shown and described for the purposes of illustration only. More or fewer buttons may be implemented.

In one embodiment, organization structure display area 402 includes a first field to display an organization structure identity (ID), a second field to display a description of the organization structure, a third field to display a primary language type, a fourth field to display a secondary language type. According to certain embodiments of the invention, some or all of these fields may be edited within GUI 400, for example, via a dialog window 405, which may be implemented as a pop-up window. Window 405 may be displayed via an activation originated from area 402 (e.g., a right click, etc.) Alternatively, window 405 may be displayed via an activation of an item from a pull-down menu (not shown).

In one embodiment, area 403 may be used to display and edit certain variants of a business solution. In this example, a global variant table is displayed including a first column for displaying variable types (which may be assigned when maintaining global variable parameters at BC-sets or eCATTs), a second column for displaying the description of the associated variant, a third column for displaying the default value, and a fourth column to allow a user to set a new value overriding the default value, for example, using a user interface similar to the window 405.

In one embodiment, display area 404 includes a first column 412 to display organization unit codes of organization units, a second column 413 to display organization unit type, and a third column 414 to display the description of the corresponding organization unit. Some or all of these fields may be editable, particularly, columns 412 and 414, for example, using a user interface similar to window 405. For example, when an entry is highlighted and a right-click is received, a button or control having a message of “change value” may be displayed. In response to an activation of the button or control, a dialog window similar to window 405 may be displayed to allow a user to set different organization unit codes to certain organization units. This configuration may also be applied to edit certain global variants in area 403.

After all of the changes have been saved, the IDE will propagate the changes to all areas or components that utilize the updated information, such as, for example, components 110-113 of solution 102, as well as data 103 of FIG. 1. As a result, GUI 400 provides a central user interface to allow a user to change any parameters or attributes related to an organization structure and the system will automatically propagate the changes to all affected areas of the business solution. Other configurations may also exist.

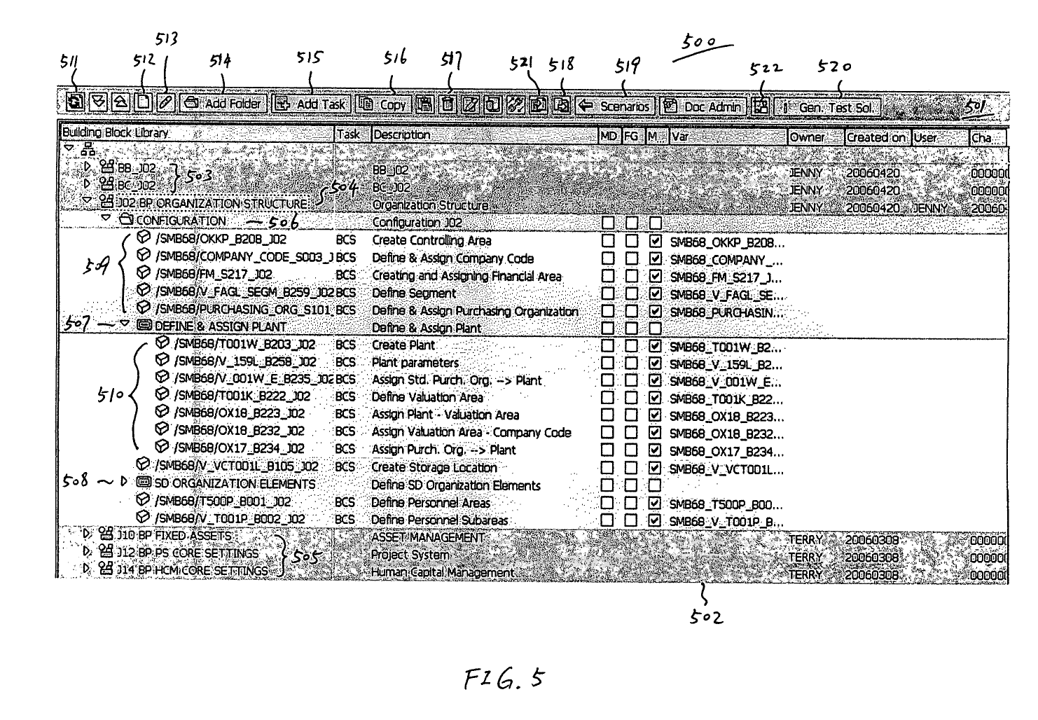

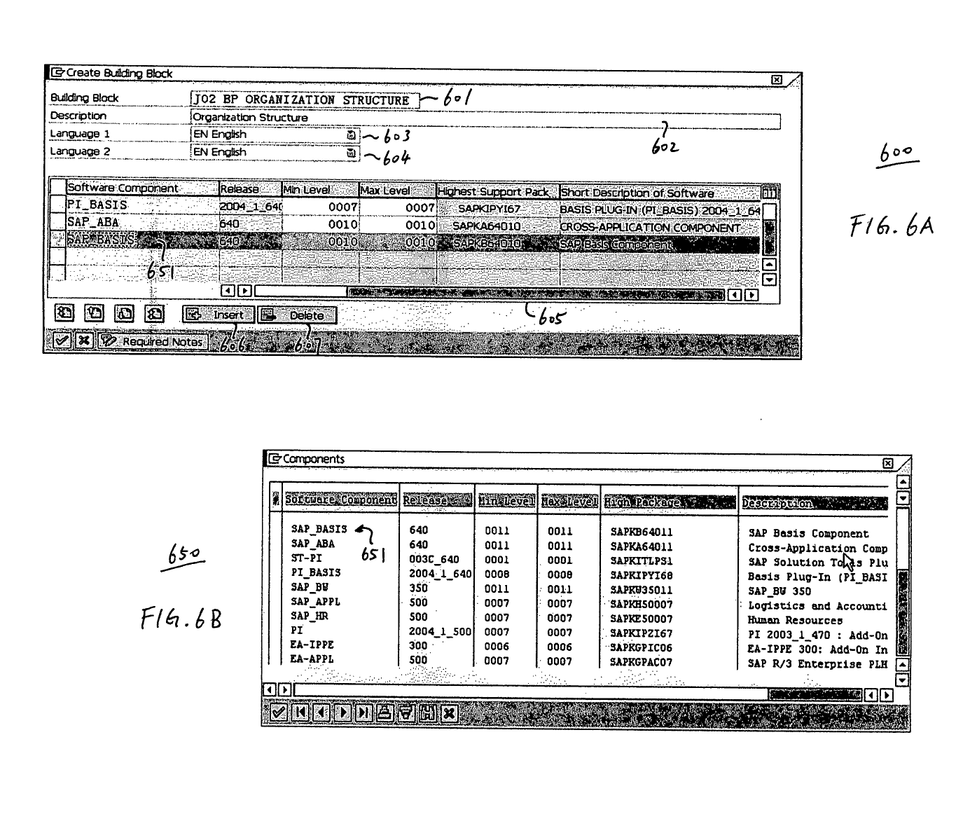

FIG. 5 is a diagram illustrating a GUI of an IDE for developing and/or deploying a business solution according to one embodiment of the invention. For example, GUI 500 may be a part of GUI 104 of FIG. 1, particularly, representing some or all of the functionalities of building block builder 106. GUI 500 may be originated from another GUI page of the IDE, such as, for example, GUI 300 of FIG. 3. In one embodiment, GUI 500 may be used to manipulate (e.g., create, modify, and/or delete) a building block, such as, for example, building blocks 110 of FIG. 1.

Referring to FIG. 5, GUI 500 includes, but is not limited to, a toolbar 501 and a display area 502, where the toolbar 501 may be used to manipulate any one of the building blocks displayed in the display area 502. Toolbar 501 includes one or more buttons or controls, which when activated, perform certain manipulation operations on the building blocks. Note that the functionalities of buttons or controls of toolbar 501 may also be implemented in other manners, such as, for example, a pull-down menu, etc. As described above, GUI 500 is presented for the purposes of illustration only. Other configurations may exist.

In one embodiment, display area 502 may be used to display some or all of the building blocks associated with a business solution being built. In this example, display area 502 displays building blocks 503-505. Some of the building blocks may include folders (e.g., folders 506-507) and some folders may include some sub-folders (e.g., sub-folders 507-508). Each of the building blocks, folders, and sub-folders may include one or more tasks (e.g., tasks 509-510). In this example, building block 504 includes folder 506. Folder 506 includes tasks 509, as well as sub-folders 507 and 508. Sub-folder 507 includes tasks 510. Again, this configuration is shown for the purposes of illustration only, while other configurations may exist.

In one embodiment, all of the invention displayed within display area 502 may be refreshed via an activation of refresh button 511. Each of the building blocks 503-505 may be created via an activation of building block create button 512. FIGS. 6A and 6B are diagrams illustrating GUIs for creating a building block according to one embodiment of the invention. Referring to FIGS. 6A and 6B, GUI 600 may be displayed via an activation of button 512 of FIG. 5.

Referring to FIGS. 6A and 6B, according to one embodiment, GUI 600 includes a field 601 to allow a user to specify an identity of a building block being created. GUI 600 further includes a description field 602 to enter the description describing the building block being created, a primary language field 603 and secondary language field 604 to specific primary and secondary languages respectively. GUI 600 further includes a display area 605 to display one or more components associated with the building block being created. In one embodiment, any one of the components displayed within the display area 605 may be deleted via an activation of button 607. Similarly, an additional component may be added or inserted into or associated with the building block being created via an activation of button 606.

For example, component 651 is inserted into the building block and displayed within display area 605. Specifically, according to a specific embodiment, when button 606 is activated, GUI 650 of FIG. 6B may be displayed containing some or all of the components available. In this example, component 651 may be added to the display area 605 of FIG. 6A, for example, by dragging and dropping component 651 from GUI 650 of FIG. 6B to display area 605 of FIG. 6A. Other ways may be implemented to select a component from GUI 650 to GUI 600.

Referring to back to FIG. 5, a folder (e.g., folder 506 and/or sub-folders 507-508) may be added via button 514 or may be removed from the list via button 517. A task (e.g., tasks 509-510) may be added via button 515 or may be removed from the list. A building block and/or a task may be copied to generate a new one via button 516. In one embodiment, a building block and/or its folders or tasks may be modified via button 513.

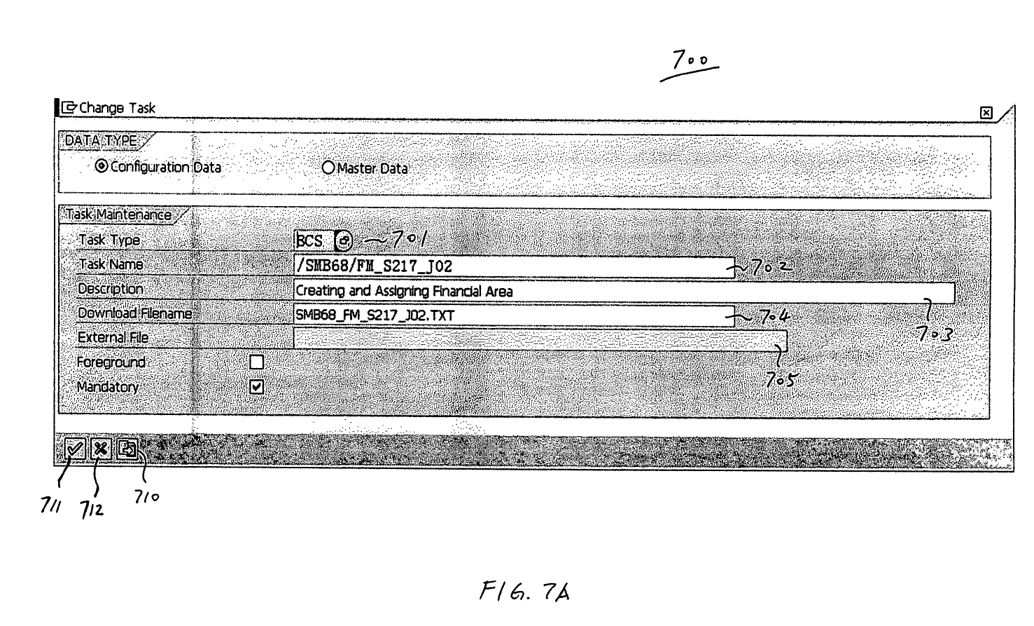

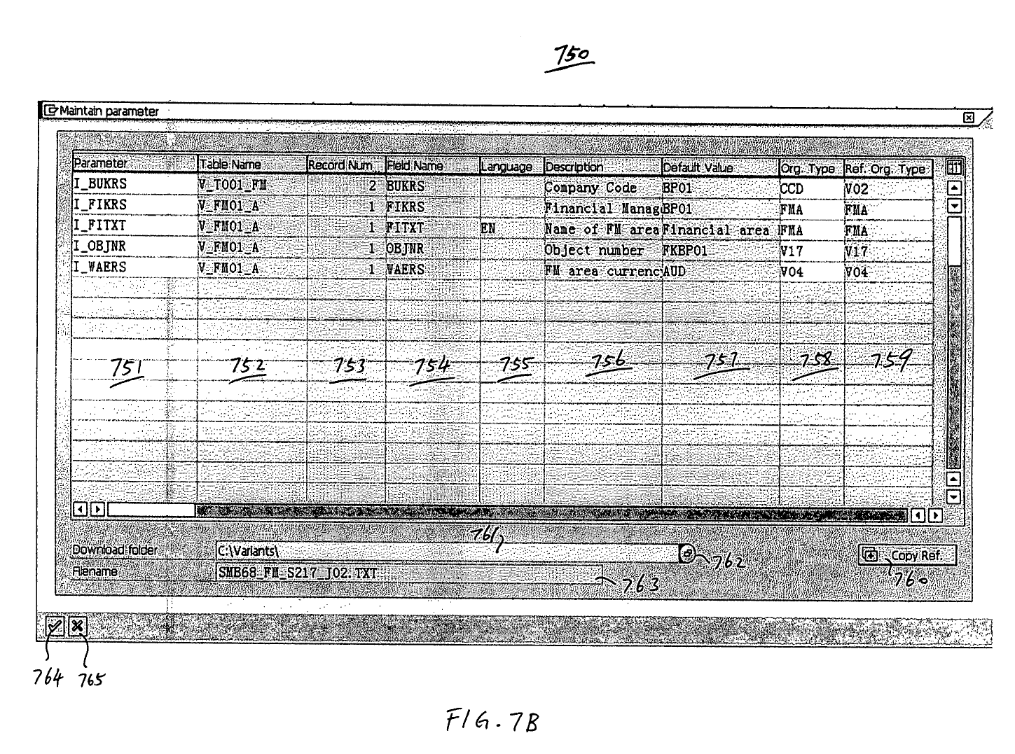

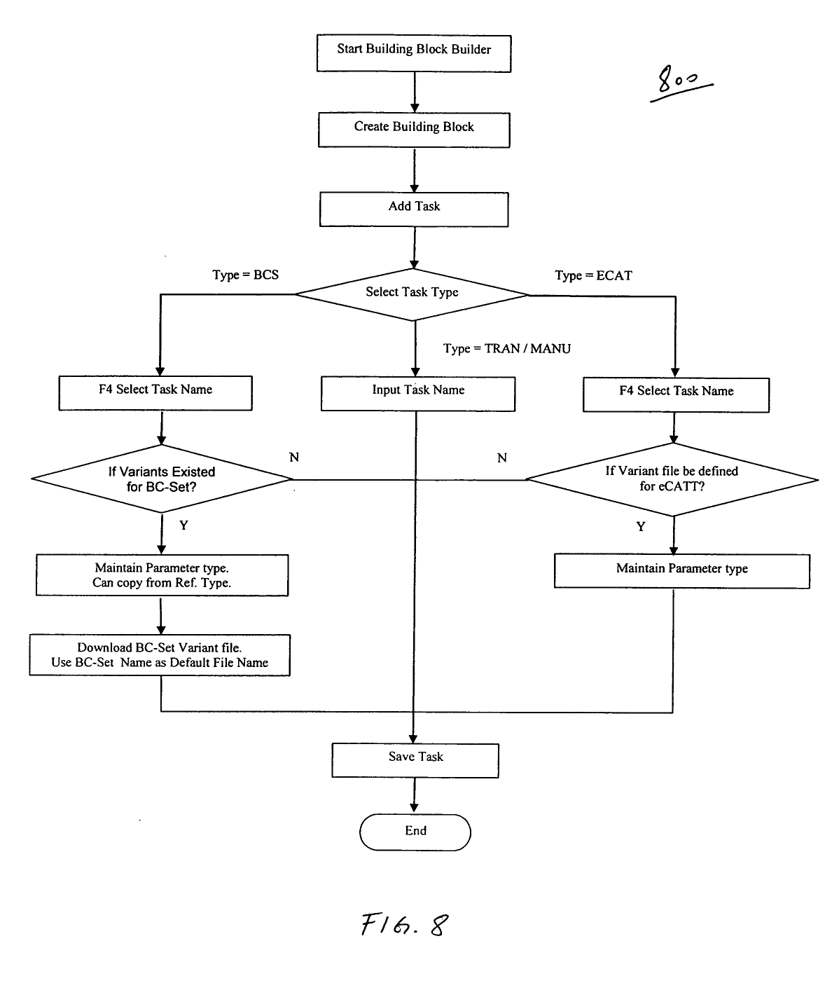

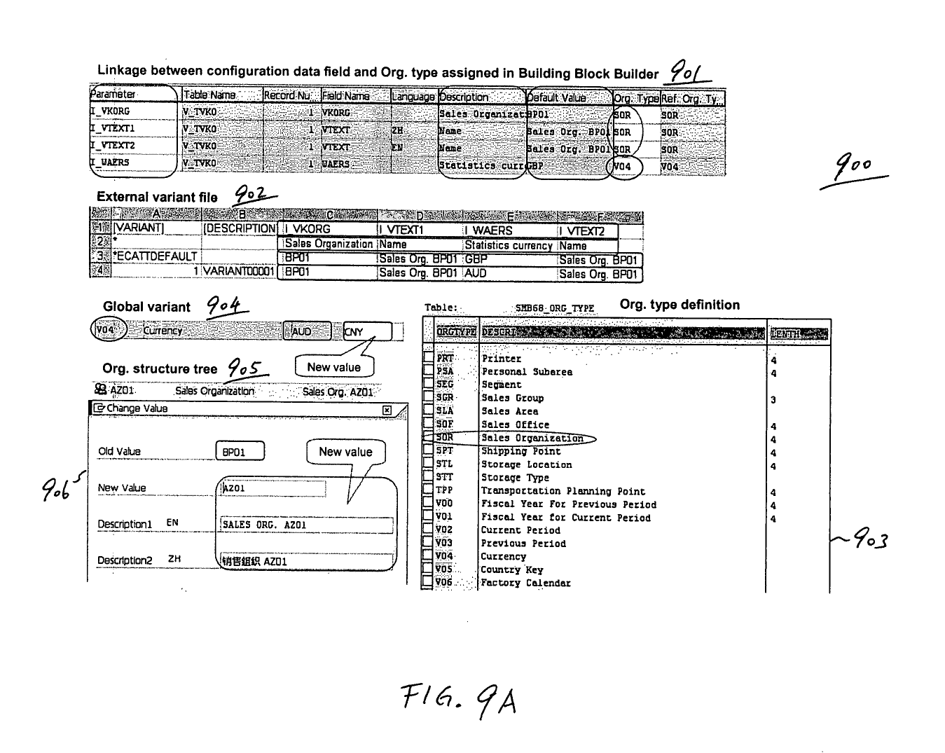

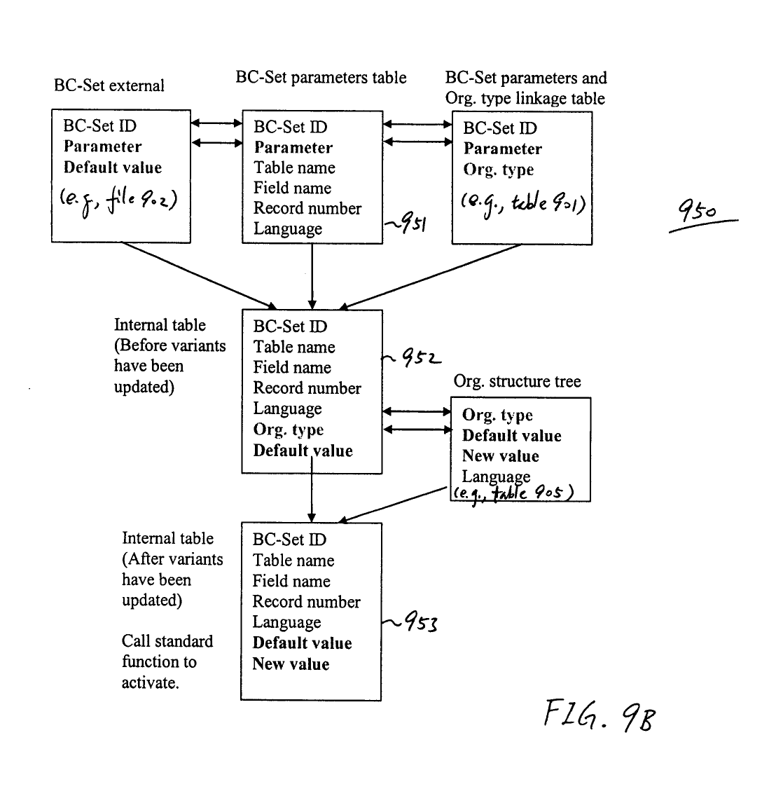

FIGS. 7A and 7B are diagrams illustrating GUIs for manipulating a task of a building block, according to one embodiment of the invention. For example, GUI 700 of FIG. 7A may be displayed via an activation of button 513 of FIG. 5. According to certain embodiments of the invention, GUI 700 of FIG. 7A may be used to add and/or modify a task of a building block, such as, for example, tasks 509-510 of FIG. 5.

Referring to FIG. 7A, GUI 700 includes a field 701 to specify a type of a task being manipulated, a field 702 to specify a name of the task being edited, a field 703 to enter the description about the task being edited, and a field 704 to specify a download file name to maintain certain variants associated with the task. In one embodiment, a type of a task being edit specified in field 701 may be selected as one of a BC-set, eCATT, manual instruction steps, and/or a transaction code, for example, by pressing a key of “F4”. If the task has a type of eCATT, GUI 700 further includes a field 705 to specify an external file name to store the parameters for the eCATT type of a task. The changes of the task can be saved in the system by activating button 711. Otherwise, the changes can be canceled by activating button 712. In one embodiment, the download file specified in field 704 may be used to maintain parameters for a BC-set, for example, by activating button 710.

FIG. 7B is a block diagram illustrating an example of a download file for a BC-set, according to one embodiment of the invention. For example, GUI 750 may be displayed or activated via an activation of button 710 of FIG. 7A. Referring to FIG. 7B, according to one embodiment, for each parameter listed in column 751, certain standard attributes associated with the respective parameter are displayed in columns 752-756, such as, for example, a table name, record number, field name, language, description, etc. If a parameter is associated with an organization type, a default organization type may be displayed within column 757.

In one embodiment, GUI 750 further includes column 758 to specify a user defined organization unit type, which may be different from the default organization unit type listed in column 757 or any modified organization unit type (e.g., modified via GUI 405 of FIG. 4A). In addition, a user may copy a referenced organization type from column 759 upon an activation of button 760. If a user does not want to copy the organization unit type from column 759, a user may select one from a list maintained by the system, for example, by pressing a key of “F4”.

In one embodiment, the user defined organization unit type in column 758 may be used to link the respective parameter to a new organization unit type (e.g., modified via GUI 405 of FIG. 4A), when the corresponding building block is deployed or activated. As a result, a user may activate a building block using a user defined (e.g., personalized) organization unit type.

In one embodiment, GUI 750 further includes a download folder field 761 to allow a user to specify a path in which the download file specified in field 763 may be stored. Alternatively, a user may browse for a path or folder by activating button 762. Upon activating button 764, the information of GUI 750 will be saved in the system. The changes will be canceled upon activating button 765. Again, GUI 750 is described and shown for the purposes of illustration only. GUI 750 is typically useful for a task having a BC-set type. For other types, the corresponding GUI may be implemented differently. For example, for a task having an eCATT type, column 757, column 759, and/or button 760 may not be needed. Other configurations may exist.

Referring back to FIG. 5, according to one embodiment, a building block may be exported to an external file via an activation of button 518. Similarly, a building block may be imported into the current solution or project via an activation of button 521. Further, an external file may be edited upon an activation of button 522 using an editor, either internally built-in or a third party editor (e.g., a spreadsheet editor, etc.) From GUI 500, a user may transition to a scenario composer (e.g., scenario composer 107 of FIG. 1) GUI via an activation of button 519, which will be described in details further below. Furthermore, according to one embodiment, one or more selected building blocks may be used to generate a solution for testing purposes via an activation of button 520, which transitions to a solution builder (e.g., solution builder 108 of FIG. 1) GUI, which will also be described in details further below. Other functionalities may also be implemented.

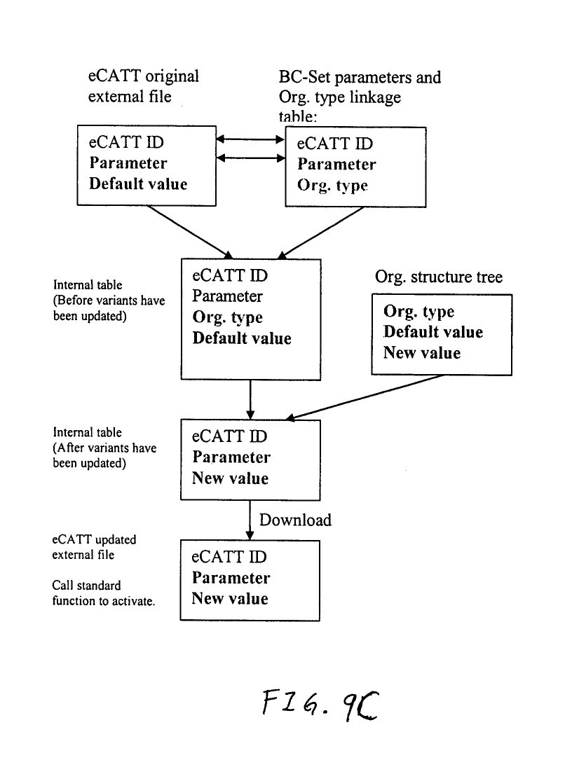

FIG. 8 is a flow diagram illustrating a process for building and/or modifying a building block according to one embodiment of the invention. Process 800 may be performed by processing logic that may include software, hardware, or a combination of both. For example, process 800 may be performed by a building block builder associated with GUIs as shown in FIGS. 5, 6A-6B, and/or 7A-7B, as described above.

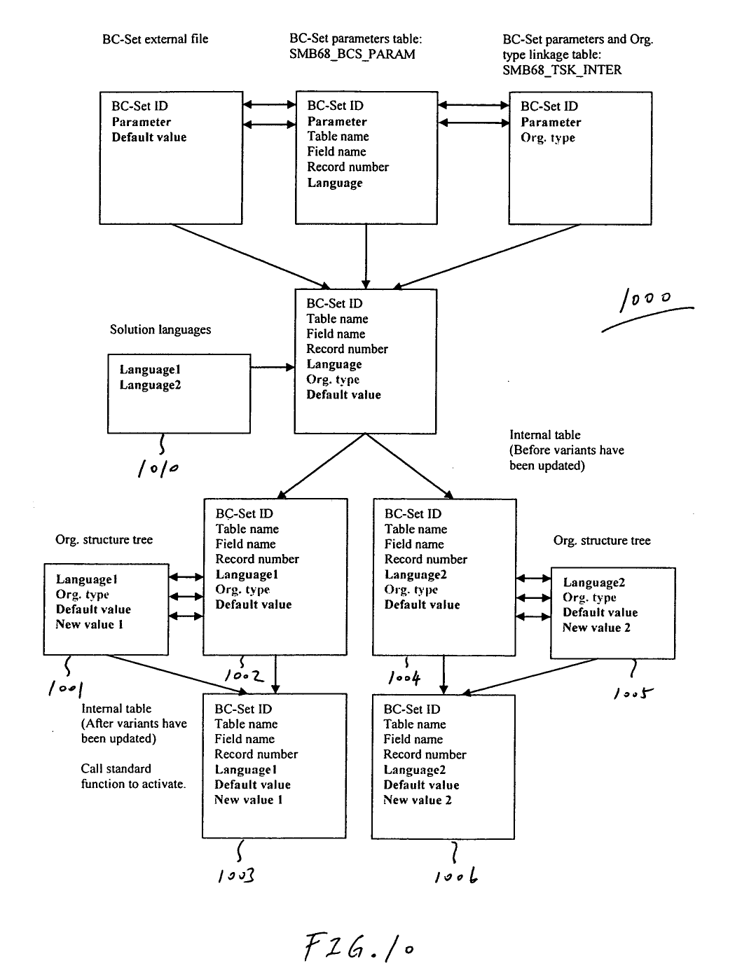

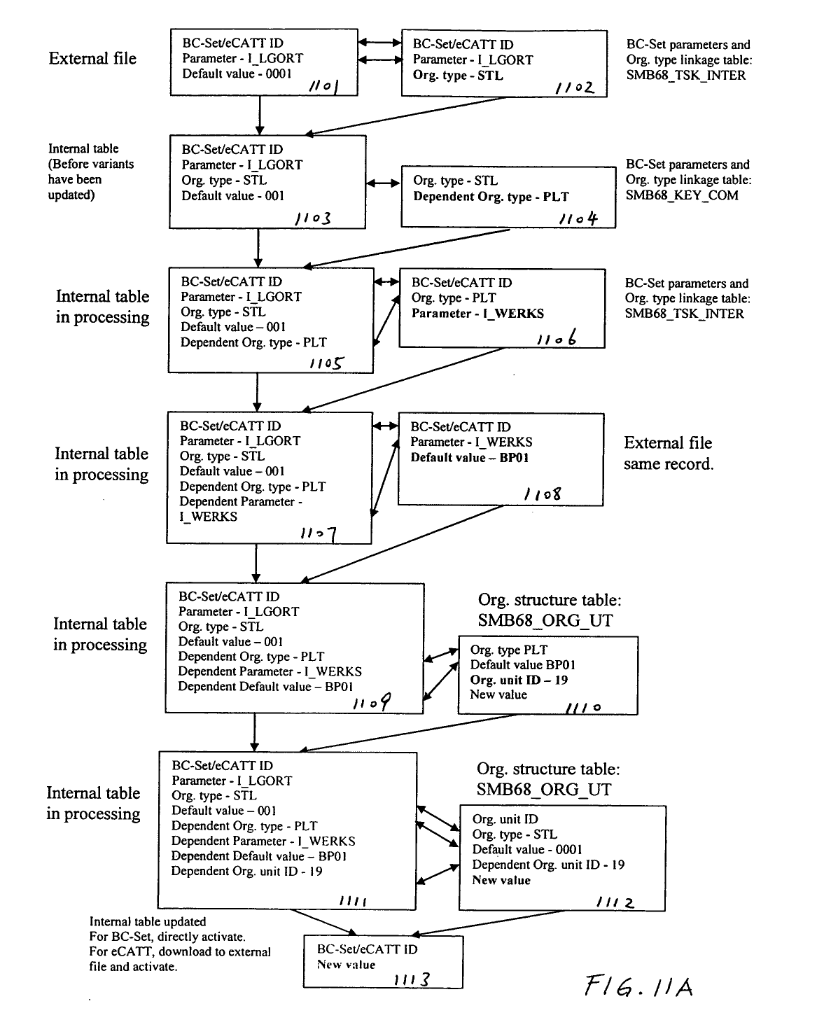

FIGS. 9A and 9B are diagrams illustrating a process for activating a building block using user defined organization type, according to one embodiment of the invention. Again, Process 950 may be performed by processing logic that may include software, hardware, or a combination of both. Referring to FIGS. 9A and 9B, linkage table 901 may be part of linkage table 750 of FIG. 7B. When a building block is activated, for example, via a solution implementation unit 109 of FIG. 1, for each parameter of the building block, linkage table 901 may be used to link an external variant file 902 with an organization tree (which may be updated with a new value), using a user defined organization type, in order to activate the corresponding parameter with a new organization type value.

For example, at block 951 of FIG. 9B, processing logic reads or coordinates an external variant file 902 and the linkage table 901 to form an internal table 952 having substantially all information of table 901. In this example, it is assumed that parameter “I_VKORG” has been identified via its external variant file 902 having a default organization type of “BP01”. From the linkage table 901, it is assumed that a user has defined a personalized organization type of “SOR” (which may have been copied from a reference organization type as described above). At block 952, an organization structure tree 905 is invoked to determine the organization type corresponding to the user defined organization type of “SOR”, which has been configured via organization type definition table 903. It is also assumed that the organization type has been modified from a default value of “BP01” to a new value of “AZ01”, via GUI 906 (similar to GUI 405 of FIG. 4A). Based on the organization tree 905, user defined organization type of “SOR”, and the default organization type of “BP01”, the new organization type value of “AZ01” is identified. At block 953, the respective parameter of a building block is activated using the new organization type value of “AZ01”.

Similarly, a global variant 904 for parameter “I_WAERS” may be activated in a manner similar to those described above. Further, a parameter having type of eCATT may be activated similarly, as shown in FIG. 9C. In one embodiment, the only difference between activation of BC-set parameters and eCATT parameters is that BC-set parameters can be activated within the system, while eCATT parameters have to be saved to an external file prior to the activation. It appreciated that the techniques described above may also be applied to other types of parameters and/or linkages. For example, the above techniques may also be applied to language dependent organization types.

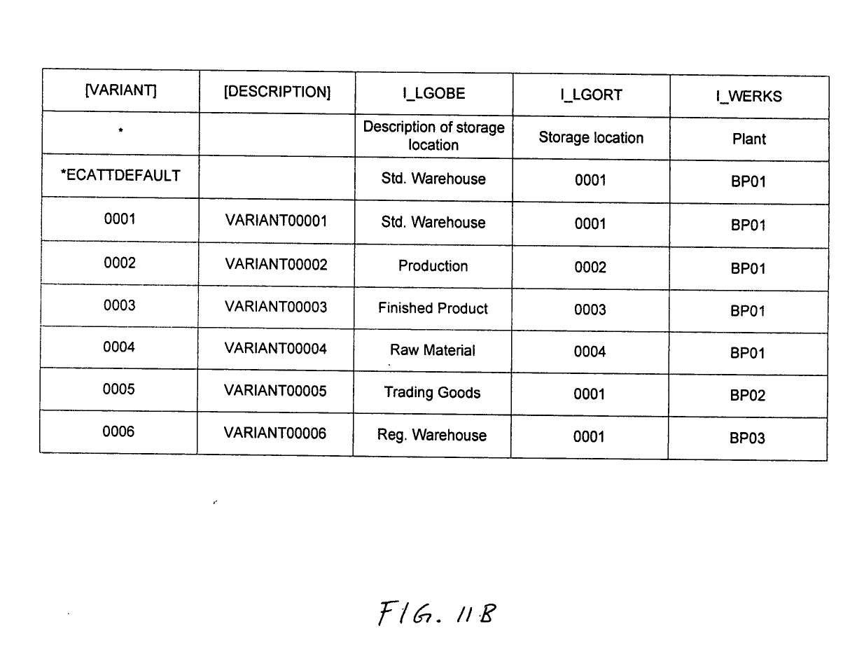

FIG. 10 is a block diagram illustrating a process to activate parameters of a building block having language dependent organization types, according to one embodiment of the invention. Referring to FIG. 10, in this example, a language linkage table 1010 having “Language 1” and “Language 2” is maintained. “Language 1” and “Language 2” may be specified when an organization structure is defined, for example using GUI 400 of FIG. 4A. For each language, process 800 of FIG. 8 may be performed to activate each parameter with new language dependent organization type (e.g., blocks 1001-1003 for “Language 1” and blocks 1004-1006 for “Language 2”).

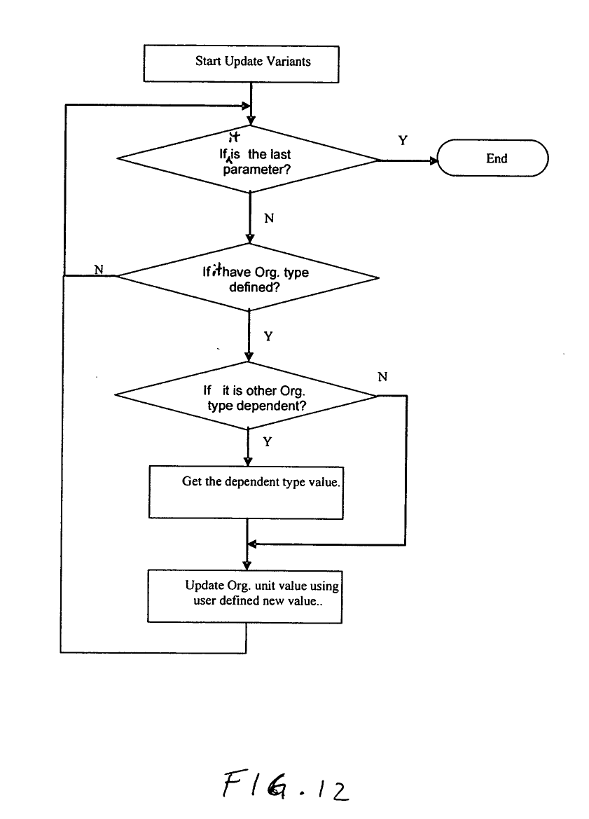

FIGS. 11A and 11B are block diagrams illustrating a process to activate parameters of a building block having storage location dependent organization types, according to one embodiment of the invention. In this example, it is assumed that a building block has an external variant file including one or more parameters, such as parameters “I_LGORT” and “I_WERKS”, as shown in FIG. 11B. Although plants “BP01” and “BP02” have the same storage location ID of “0001”; however, the actual organization unit types for the storage locations may be different. As a result, such parameters have to be activated properly.

In this example, parameters “I_LGORT” and “I_WERKS” are used for the purposes of illustration; other parameters may also be applied. Referring to FIGS. 11A and 11B, at block 1101, from the external variant file as shown in FIG. 11B, a default value of “0001” for parameter “I_LGORT” is identified. At block 1102, from a first linkage table of “SMB68_TSK_INTER” (similar to the one shown in FIG. 7B), the organization type of “STL” associated with parameter “I_LGORT” is determined and an internal table is updated at block 1103. Based on the organization type “STL”, at block 1104, processing logic checks whether there is a dependent organization type exist based on a second linkage table of “SMB68_KEY_COM”, which may or may not be the same table as the first linkage table. In this example, there is a dependent organization type of “PLT”, and an internal table is updated at block 1105.

At block 1106, based on the dependent organization type of “PLT”, at block 1106, another linkage table (herein the first linkage table) is checked to locate the dependent parameter “I_WERKS”, and the internal table is updated at block 1107. At block 1108, a default organization type associated with the dependent parameter “I_WERKS” is identified. In this example, the default organization type for parameter “I_WERKS” is “BP01”. At block 1109, the internal table is updated accordingly.

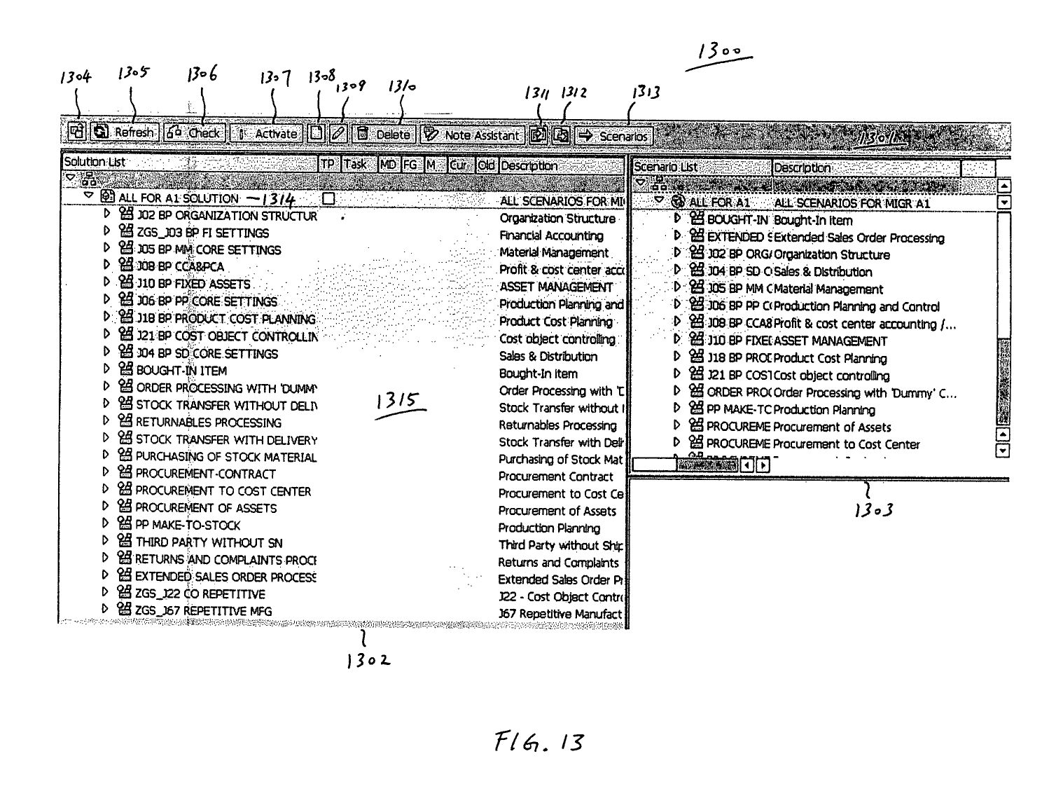

At block 1110, based on the organization type of “PLT” and its default value of “BP01”, the associated organization unit ID of “19” is identified, and the internal table is updated accordingly at block 1111. At block 1112, based on the organization unit ID for organization type “STL”, default value of “0001”, as well as dependent organization unit ID of “19”, the new value is identified and internal table is updated at block 1113. The new value may be used when the corresponding BC-set or eCATT is activated. FIG. 12 is a flow diagram illustrating a process of activating a parameter having dependent values as described above according to one embodiment of the invention. Other operations may also be performed.

FIG. 13 is a diagram illustrating a GUI of a solution implementation according to one embodiment of the invention. For example, GUI 1300 may be implemented as a part of solution implementation unit 109 of FIG. 1. In one embodiment GUI 1300 may be presented via an activation of item 307 of FIG. 3. In one embodiment, GUI 1300 includes a toolbar 1301 having one or more buttons or controls, display area/window 1302 to display all of the solutions available in the system, and a display area 1303 for displaying all of the scenarios available to be selected for one or more of the solutions listed in window 1302. In one embodiment, window 1303 may be displayed via button 1304. A scenario includes a comprehensive business flow as a series of different individual processes that are linked sequentially and logically. In one embodiment, an event-driven process chain is used to portray a scenario.

In this example, solution 1314 includes one or more scenarios 1315 currently used by the solution 1314. In one embodiment, an additional scenario may be selected from window 1303 and added into a solution displayed in window 1302, for example, via a drag-n-drop operation. Similarly, any one of the scenarios listed in window 1302 and associated with a solution may be removed. The list of scenarios 1315 may be refreshed via button 1305, particularly, after certain editions.

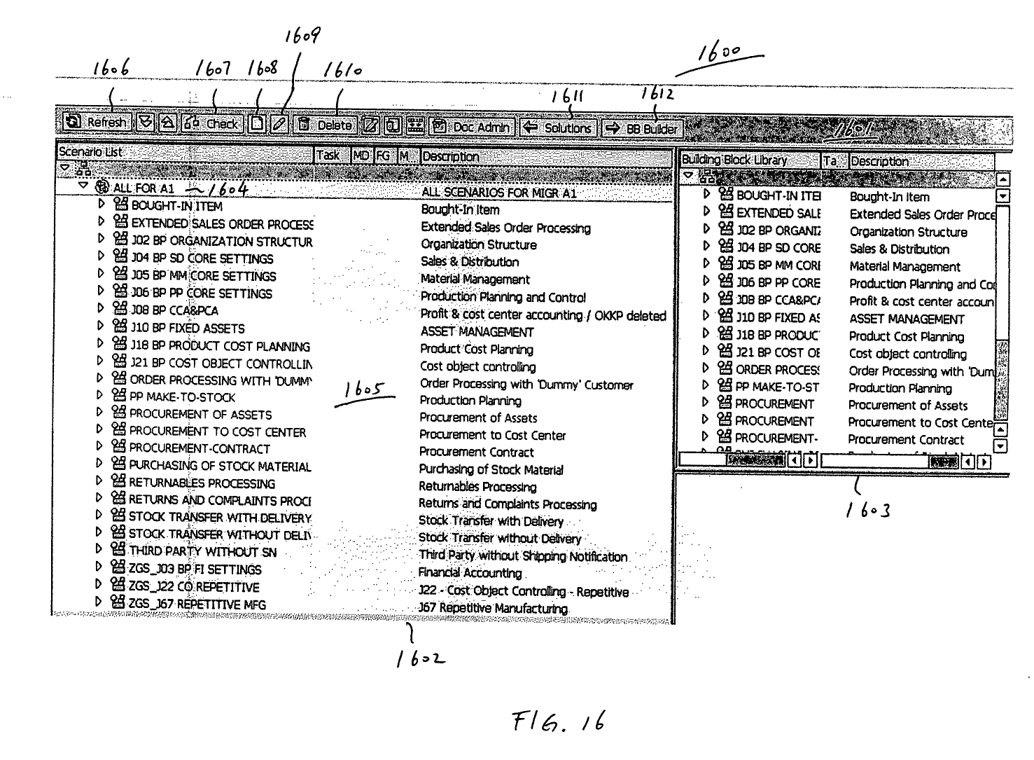

In one embodiment, a solution displayed in window 1302 may be checked or verified via button 1306 to remove certain possible errors. Any one of the solutions displayed in window 1302 may be activated via button 1307, for example, via GUI 1500 of FIG. 15. Similarly, any one of the solutions displayed in window 1302 may be modified via button 1309. A new solution may be created via button 1308, which may also be copied from another existing solution. Similarly, any one of the solutions displayed in window 1302 may be deleted or removed via button 1310. An external solution may be imported into the system via button 1311 and similarly, any one of the solutions listed in window 1302 may be exported via button 1313. Other functionalities or buttons may also be included.

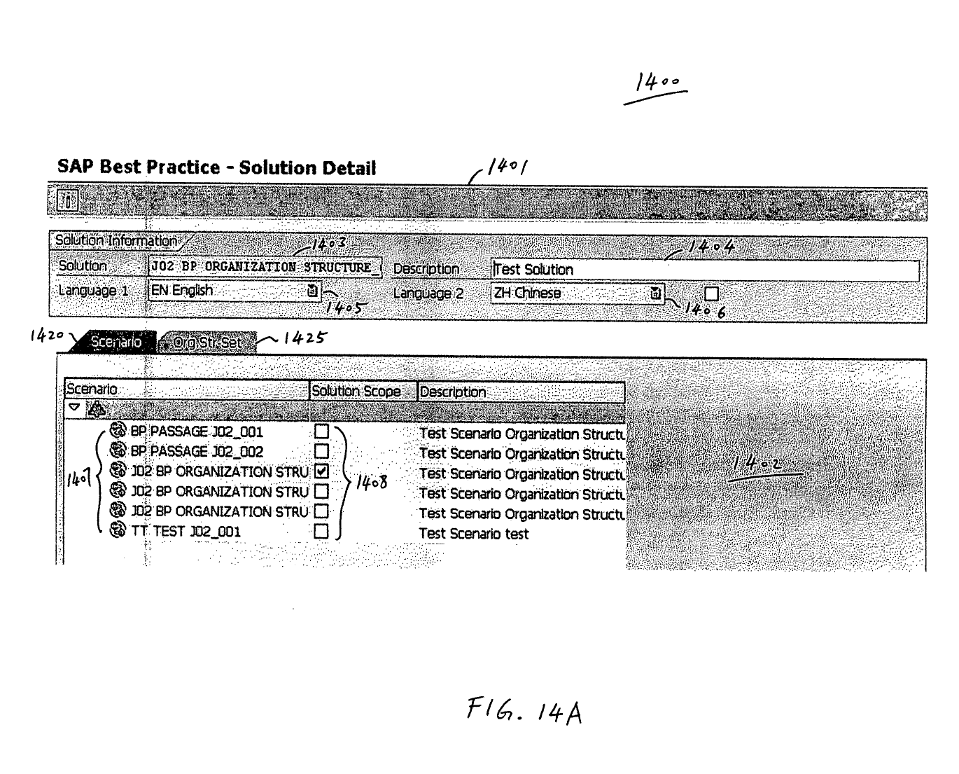

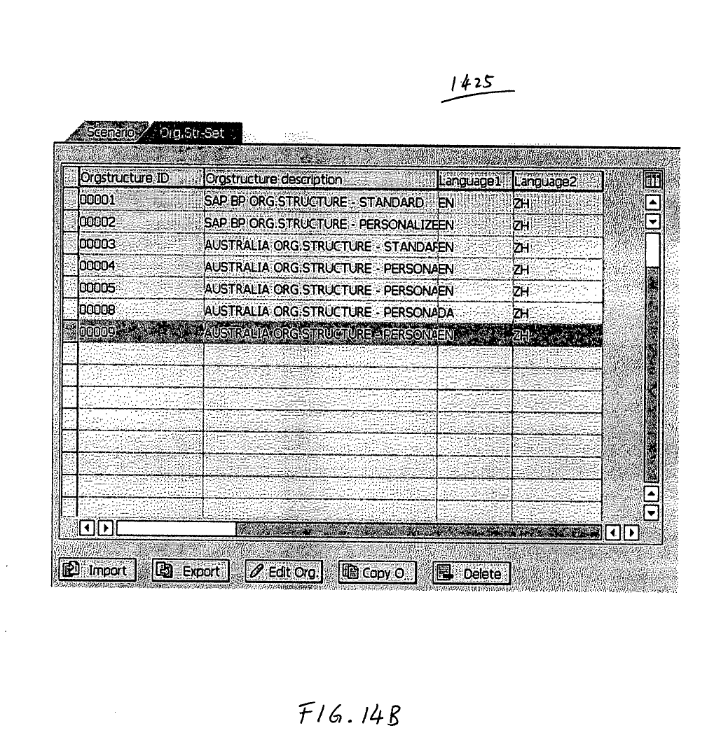

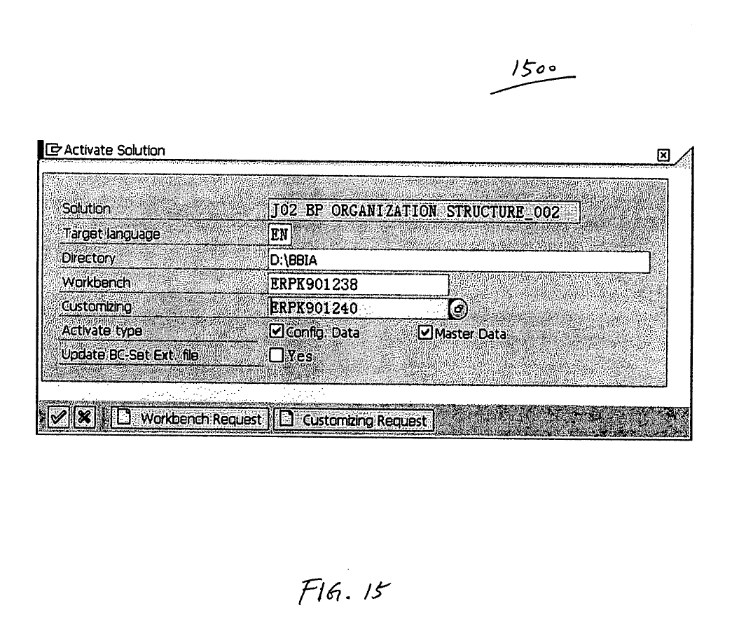

FIGS. 14A and 14B are diagrams illustrating GUIs of modifying or editing a solution according to one embodiment of the invention. For example, GUI 1400 may be activated via button 1309 of GUI 1300 shown in FIG. 13. In one embodiment, in response to an activation of button 1309, certain detailed information of a solution selected from window 1302 may be displayed in GUI 1400 of FIG. 4A. Referring to FIG. 14A, GUI 1400 includes GUI 1401 having a first field 1403 to specify a name or identification of the current solution and a second field 1404 to specify the description of the current solution. In addition, GUI 1401 further includes a primary language field 1405 and a secondary language field 1406 to specify the primary and secondary languages associated with the current solution.

GUI 1400 further includes GUI 1402 to display further detailed information of the current solution, including, for example, scenario page 1420 and organization string set page 1425. In this example, page 1420 is activated to display all of the scenarios 1407 available to be included into the current solution. For example, according to one embodiment, any one of the scenarios 1407 may be selected by checking an associated checkbox 1408. FIG. 14B is a diagram illustrating an example of GUI 1425. As shown in FIG. 14B, any of the organization structure may be assigned to the current solution per language basis. Furthermore, an organization structure may be imported, exported, copied, edited, and/or deleted from the current solution, as shown in FIG. 14B.

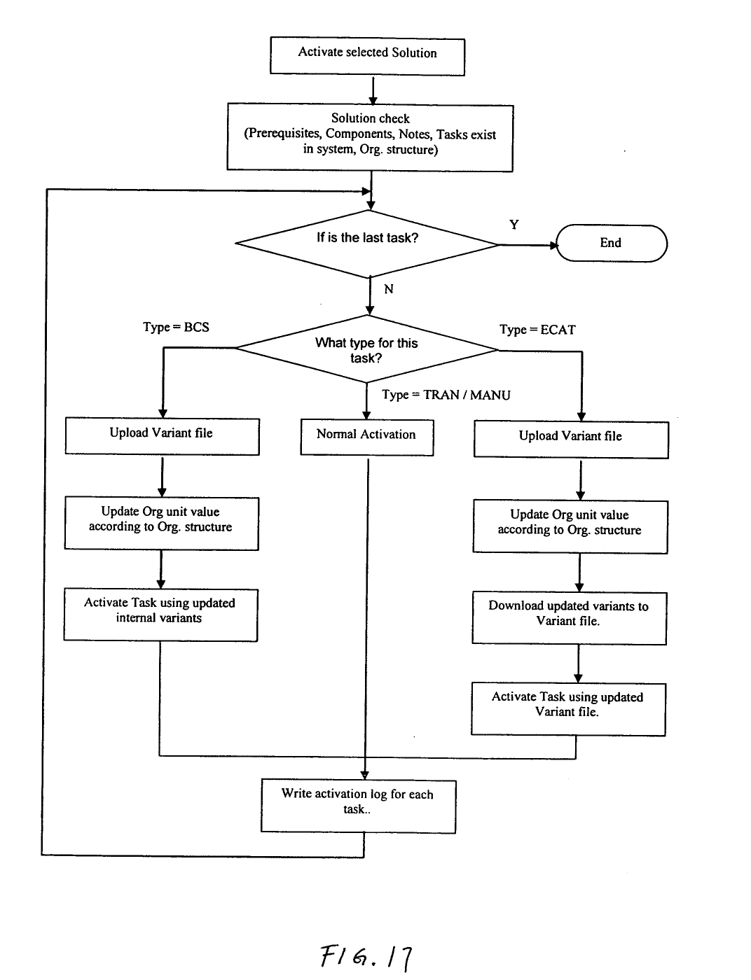

FIG. 16 is a diagram illustrating a GUI of a scenario composer according to one embodiment of the invention. For example, GUI 1600 may be implemented as a part of scenario composer 107 of FIG. 1. GUI 1600 may be presented via activation of button 519 of FIG. 5 and/or button 1313 of FIG. 13. Referring to FIG. 16, GUI 1600 includes a toolbar 1601 having one or more buttons or controls, which when activated, perform certain functionalities or operations. GUI 1600 further includes a display area or window 1602 to display all of the scenarios in the system and a display area or window 1603 to display all of the building blocks available to be included into any one of the scenarios displayed in window 1602. For example, scenario 1604 may include one or more building blocks 1605 selected from those listed in window 1603, for example, via a drag-n-drop operation.

In one embodiment, the scenario list displayed in window 1602 may be refreshed to update any changes via button 1606. Any one of the scenarios displayed in window 1602 may be checked or verified to determine whether there is any error in the corresponding scenario via button 1607. A new scenario may be added via button 1608. Any one of the scenarios displayed in window 1602 may be modified or edited via button 1609. Similarly, any one of the scenarios displayed in window 1602 may be deleted or removed via button 1610. GUI 1600 of FIG. 16 may be transitioned to other GUI pages, such as, for example, GUI 1300 of FIG. 13 via button 1611 and/or GUI 500 of FIG. 5 via button 1612. FIG. 17 is a flow diagram illustrating a process for activating a solution, which may be performed by a processing logic having software, hardware, and/or a combination of both, according to one embodiment of the invention. Other configurations may also be included.

Thus, integrated development environment (IDE) for developing and deploying business solutions has been described herein. Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), erasable programmable ROMs (EPROMs), electrically erasable programmable ROMs (EEPROMs), magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method operations. The required structure for a variety of these systems will appear from the description below. In addition, embodiments of the present invention are not described with reference to any particular programming language. It will be appreciated that a variety of programming languages may be used to implement the teachings of embodiments of the invention as described herein.

A machine-readable medium may include any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A computer implemented method for developing an enterprise application, the method comprising:
presenting via a first page of a graphical user interface (GUI) data of an organization structure representing a structure of an enterprise entity associated with the enterprise application, the organization structure having one or more attributes that are editable via the first page of the GUI; and
in response to a request to change at least one attribute of the organization structure via the first page of the GUI, propagating the change in one or more components of the enterprise application that reference to the at least one changed attribute.

2. The method of claim 1, further comprising presenting in the first page of the GUI data representing global variants used by the enterprise application, wherein at least one of the global variants displayed is editable.

3. The method of claim 1, wherein the organization structure is represented in a hierarchy tree having a plurality of nodes, each node representing an organization unit of the enterprise entity, and wherein the one or more attributes that are editable comprise an organization unit code uniquely identifying an associated organization unit.

4. The method of claim 3, further comprising deploying via a second page of the GUI the one or more components having the at least one changed attribute to generate a solution for the enterprise application using the at least one changed attribute rather than a corresponding default attribute.

5. The method of claim 4, wherein each of the components comprises a configuration data set used to configure the corresponding component when the corresponding component is deployed.

6. The method of claim 5, further comprising maintaining one or more parameters of the configuration data set for each component, wherein at least one parameter references to one of the organization unit via the corresponding organization unit code.

7. The method of claim 6, wherein the one or more parameters of the configuration data set are stored in an external file associated with the configuration data set, wherein deploying one or more components further comprises:
for each of the one or more parameters stored in the external file, retrieving an organization unit code associated with a respective parameter;
identifying an organization unit based on the retrieved organization unit code;
configuring the respective parameter using information associated with the identified organization unit; and
activating the configuration data set using the configured one or more parameters.

8. A machine-readable medium having instructions, when executed, cause a machine to perform a method for developing an enterprise application, the method comprising:
presenting via a first page of a graphical user interface (GUI) data of an organization structure representing a structure of an enterprise entity associated with the enterprise application, the organization structure having one or more attributes that are editable via the first page of the GUI; and
in response to a request to change at least one attribute of the organization structure via the first page of the GUI, propagating the change in one or more components of the enterprise application that reference to the at least one changed attribute.

9. The machine-readable medium of claim 8, wherein the method further comprises presenting in the first page of the GUI data representing global variants used by the enterprise application, wherein at least one of the global variants displayed is editable.

10. The machine-readable medium of claim 8, wherein the organization structure is represented in a hierarchy tree having a plurality of nodes, each node representing an organization unit of the enterprise entity, and wherein the one or more attributes that are editable comprise an organization unit code uniquely identifying an associated organization unit.

11. The machine-readable medium of claim 10, wherein the method further comprises deploying via a second page of the GUI the one or more components having the at least one changed attribute to generate a solution for the enterprise application using the at least one changed attribute rather than a corresponding default attribute.

12. The machine-readable medium of claim 11, wherein each of the components comprises a configuration data set used to configure the corresponding component when the corresponding component is deployed.

13. The machine-readable medium of claim 12, wherein the method further comprises maintaining one or more parameters of the configuration data set for each component, wherein at least one parameter references to one of the organization unit via the corresponding organization unit code.

14. The machine-readable medium of claim 13, wherein the one or more parameters of the configuration data set are stored in an external file associated with the configuration data set, wherein deploying one or more components further comprises:
for each of the one or more parameters stored in the external file, retrieving an organization unit code associated with a respective parameter;
identifying an organization unit based on the retrieved organization unit code;
configuring the respective parameter using information associated with the identified organization unit; and
activating the configuration data set using the configured one or more parameters.

15. An integrated development platform for developing an enterprise application, comprising:
an organization structure composer for presenting via a first page of a graphical user interface (GUI) data of an organization structure representing a structure of an enterprise entity associated with the enterprise application, the organization structure having one or more attributes that are editable via the first page of the GUI; and
a component builder, in response to a request to change at least one attribute of the organization structure via the first page of the GUI, for propagating the change in one or more components of the enterprise application that reference to the at least one changed attribute.

16. The integrated development platform of claim 15, wherein the organization structure composer is configured to present the organization structure in the first page of the GUI data representing global variants used by the enterprise application, wherein at least one of the global variants displayed is editable.

17. The integrated development platform of claim 15, wherein the organization structure is represented in a hierarchy tree having a plurality of nodes, each node representing an organization unit of the enterprise entity, and wherein the one or more attributes that are editable comprise an organization unit code uniquely identifying an associated organization unit.

18. The integrated development platform of claim 17, further comprising a solution implementation unit to activate via a second page of the GUI the one or more components having the at least one changed attribute using the at least one changed attribute rather than a corresponding default attribute.

19. The integrated development platform of claim 18, further comprising a solution builder to generate a solution for the enterprise application using the activated one or more components.

20. The integrated development platform of claim 18, wherein each of the components comprises a configuration data set used to configure the corresponding component when the corresponding component is deployed.
